(19) United States
(12) Patent Application Publication
(10) Pub. No.: US 2004/0083379 A1
(43) Pub. Date: Apr. 29, 2004

(54) Data processing system and method

(76) Inventors: Paul Neuman, Grenoble (FR); Yann Stephan, Echirolles (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/643,079

(22) Filed: Aug. 19, 2003

(30) Foreign Application Priority Data
Aug. 19, 2002 (EP) 02354121.2

(51) Int. Cl. G06F 12/14

(52) U.S. Cl. 713/193

(57) ABSTRACT

A data processing system comprises a processor, a non-volatile storage medium including configuration data that describes the configuration of the non-volatile storage medium, a controller for managing data exchanges with the non-volatile storage medium and for invoking an uninterruptible software routine in response to first software attempting to access the configuration data. The uninterruptible software routine has code for determining whether the first software is authorized to access the configuration data and for allowing or preventing any such access according to the determination.

### FIELD OF THE INVENTION

The present invention relates to a data processing system and method and, more particularly, to such a system for and method of controlling use of a hardware platform.

### BACKGROUND TO THE INVENTION

Manufacturers and vendors of computer equipment such as dedicated web terminals, or other computer equipment for a specific purpose, rather than a general purpose, often use state of the art technology to manufacture that equipment. However, since the equipment may be leased or sold for a limited or dedicated purpose, the lease price or purchase price may be significantly reduced compared to the same hardware platform having been sold for a more general purpose. Therefore, one may encounter a situation in which a relatively inexpensive, but technically sophisticated, hardware platform, which has been sold for a dedicated purpose, is hacked to enable that platform to be used for more general purposes.

While techniques have been developed to address the hacking, or unauthorized copying, of computer software, relatively little progress has been made in the field of protecting computer hardware against unauthorized use.

It is an object of the present invention to mitigate some of the problems of the prior art.

### SUMMARY OF THE INVENTION

Accordingly, an aspect of the present invention provides a data processing system comprising a processor, a hardware platform storage medium having configuration data that describes the configuration of the hardware platform storage medium, a controller for (1) managing data exchanges with the non-volatile storage medium and (2) invoking an uninterruptable software routine in response to first software attempting to access the configuration data. The uninterruptible software routine has code to determine whether the first software is authorized to access the configuration data and to grant or prevent any such access according to the determination. the data processing system.

Preferably, the first software comprises binary input output system (BIOS) code and the configuration data comprises at least a portion of the first data contained within a Master Boot Record. Advantageously, the BIOS code cannot gain access to the Master Boot Record, without having been authorized, which ensures that the hardware platform is tied to the BIOS and visa versa. In effect, only an authorized BIOS can use the hardware platform.

In preferred embodiments, the configuration data comprises executable code. Preferably, the executable code is Master Boot Code.

Preferably, the configuration data are encrypted. Therefore, even if the authorized BIOS is replaced with a more general BIOS that is not tied to the hardware, the Master Boot Record cannot be used in its encrypted form to gain access to the non-volatile storage medium. Hence, preferred embodiments provide a data processing system in which the controller comprises a decrypter of at least one of the configuration data and data associated with the first software. Advantageously, unless the BIOS code includes the appropriate signature, the Master Boot Record cannot be used or be decrypted, which prevents use of the Master Boot Record and, ultimately, prevents the hardware platform from being used.

Preferred embodiments provide a data processing system in which the data associated with the first software are used as a decryption key.

In preferred embodiments, the data associated with the first software comprises a software signature. Advantageously, the combination of both the BIOS code signature and the encrypted Master Boot Record ties the hardware to the BIOS and visa versa.

In the preferred embodiments, the decrypter is arranged to decrypt at least one of the data received from, or associated with, the first software and the configuration data to produce decrypted configuration data to support access to the non-volatile storage medium.

Advantage is taken of a system management mode (SMM) of operation of currently available Intel processors. Suitably, embodiments provide a data processing system in which the interrupt is a system management interrupt (SMI) and the uninterruptible software routine is system management mode code executable within a constrained or protected operating environment.

An operating system is conventionally employed to initialize a computer system so that it operates as intended. Accordingly, embodiments provide a data processing system in which the configuration data provide access to an operating system loader for loading an operating system from the non-volatile storage medium.

A further aspect of the invention concerns a system comprising a processor, a first non-volatile storage medium comprising first and second firmware and a second nonvolatile storage medium for storing configuration data that describes the configuration of the second non-volatile storage medium. The processor has a first mode of operation for executing the first firmware and a second mode of operation for executing the second firmware. The processor is arranged to enter the second mode of operation and execute the second firmware in response to the first firmware executing in the first mode of operation and attempting to access the configuration data. The second firmware is arranged to determine whether the first software is authorized to access the configuration data and to grant or refuse access to the configuration data according to the determination.

A still further aspect of the invention relates to a method of controlling a data processing system having (1) a processor, (2) first non-volatile storage storing (a) first software and (b) an uninterruptible software routine for execution within respective modes of operation of the processor, and (3) a second non-volatile storage medium storing configuration data associated with the configuration of the second non-volatile storage medium. The first software has associated identification data. The method comprises the steps of: (1) executing the uninterruptible software routine in the second mode of operation of the processor in response to the first software executing in the first mode of operation of the processor and attempting to access the configuration data; (2) determining whether the first software is authorized to access the configuration data; and (3) controlling access to the configuration data according to that determination.

The computer software can be readily transmitted electronically, e.g., via the Internet, or physically transported, e.g. via a CD. Suitably, embodiments provide a computer program element comprising code to operate a system or method as described in this specification. Furthermore, embodiments provide a computer program product comprising a computer readable storage medium having such a computer program element stored on that medium.

### BRIEF DESCRIPTION OF THE DRAWINGS

Embodiments of the present invention will now be described, by way of example only, with reference to the accompanying drawing in which:

FIG. 1 is a schematic illustration of a computer system according to an embodiment; and

FIG. 2 is a data and signal flowchart for controlling access to the MBR by the BIOS.

### DESCRIPTION OF PREFERRED EMBODIMENTS

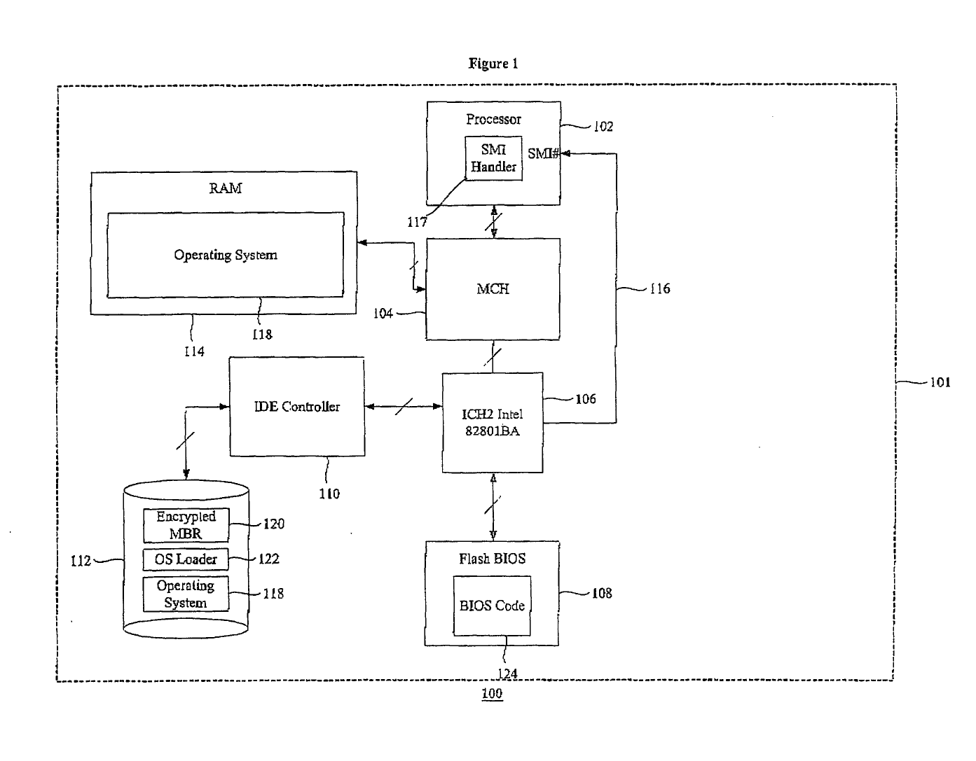

Referring to FIG. 1, there are shown, schematically, selected elements of a chipset 100 of a computer system 101. The elements of the chipset 100 comprise a processor 102, a memory hub controller (MCH) 104, an I/O controller hub (ICH2) 106, a flash BIOS 108, an IDE drive controller 110, a hard disk drive (HDD) 112, and a memory 114.

The processor 102 may be an Intel processor such as, for example, a Pentium IV processor, or any other processor with a system management mode (SMM) of operation that is comparable with the SMM of the Pentium class of processors. It will be appreciated that the SMM of operation represents a protected operating environment. The SMM of operation is invoked in response to receipt of a System Management Interrupt (SMI) 116. Upon invocation of the SMM, a SMI handler is arranged to invoke appropriate code to deal with the interrupt.

The memory hub controller 104 manages memory 114 that stores an operating system 118. The operating system 118 is retrieved from the HDD 112.

The HDD 112 comprises a Master Boot Record 120, which stores information describing both the configuration of the HDD 112, that is, the partition information, and how the BIOS 108 should boot the computer system 101. The Master Boot Record 120 contains, at the beginning, Master Boot Code (not shown), which is a relatively small program that is loaded by the BIOS 108 to allow the computer system to be booted and to allow an operating system loader 122 to be loaded and executed. The Master Boot Code uses the partition information to determine which partition is bootable. The operating system loader 122 is responsible for loading the operating system 118. It can be appreciated that without access to the Master Boot Record 120, the BIOS 108 could not boot the computer system 101.

In preferred embodiments, the Master Boot Record 120 is stored in an encrypted form so it cannot be used without having been decrypted. It will be appreciated that such an encrypted Master Boot Record 120 would prevent the computer system 101 from being booted. The Master Boot Record 120 is encrypted using data derived from, or associated with, BIOS code 124 or the BIOS itself 108.

The ICH2 106 is the Input/Output controller hub for the input-output system, which integrates many of the functions required by modern PC platforms. The ICH2 106 can be realized using an Intel 82801BA I/O Controller Hub 2 in preferred embodiments. The ICH2 106 controls access to the HDD 112 via the IDE controller 110.

Other features (not illustrated) are that a motherboard carrying chipset 100 may include elements such as a memory translator hub (MTH), which maps to DIMMs to provide system RAM, graphics facilities in the form of an AGP graphics card and, optionally, an AIMM graphics memory extension slot, a USB port, an audio modem riser, a Super I/O LPC, SMBus devices, various PCI slots, which can be used to host various cards such as communication cards, network cards, and ISA bridges on an ISA extension.

Upon initialization of the computer system 101, the processor 102 fetches and executes the BIOS code 124 via the ICH2 106. The BIOS code 124 performs a power-on self-test and, having completed that test successfully, attempts to read the Master Boot Record 120 with a view to loading the operating system loader 122. As indicated above, the OS loader 122 is responsible for loading the operating system 118 into the memory 114. The operating system loader 122 is also responsible for handing over control, or administration, of the computer system 101 to the operating system 118.

An SMI 116 is generated in response to an attempt to access the Master Boot Record 120 stored on the HDD 112. Preferably, the ICH2 106 is programmed to generate the SMI 116 if an attempt is made to access the Master Boot Record 120 of the HDD 112.

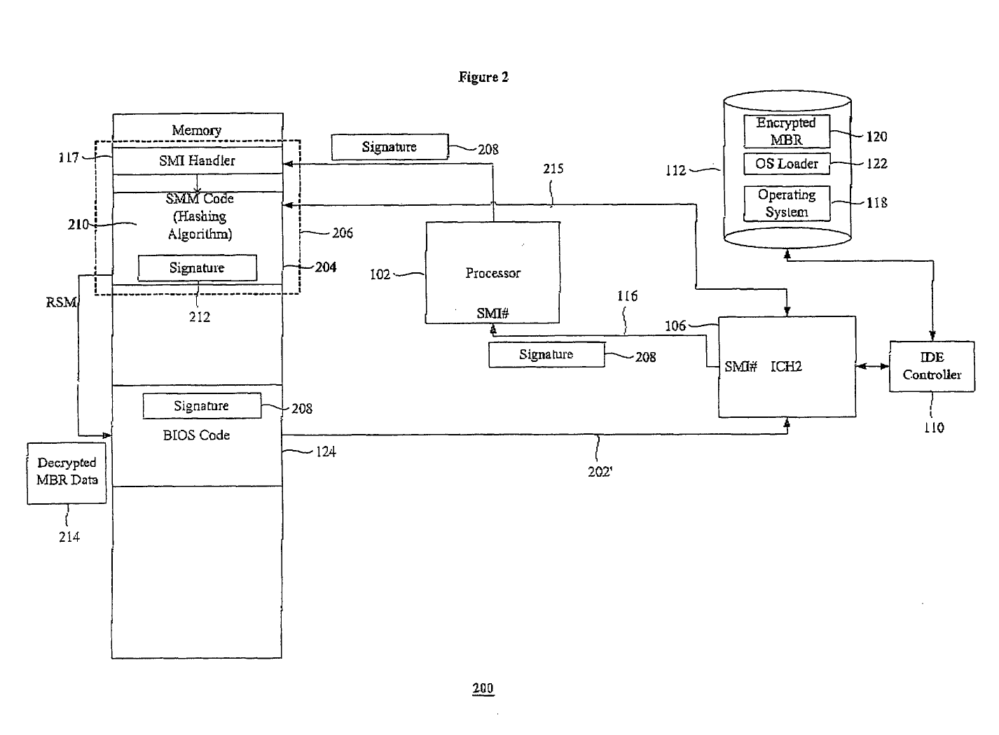

Referring to FIG. 2, there is shown an interaction 200, or flowchart of the data and signal between the elements of the chipset 100. The interaction 200 is such that if the BIOS code 124 attempts to access, or requests acess to, the Master Boot Record 120, the ICH2 106 is arranged to trap any such access attempt by generating the SMI 116 that is sent to the processor 102.

The processor 102, upon receiving the SMI interrupt 116, enters a system management mode in which control is transferred to the SMI handler 117. The SMI handler 117 is arranged to invoke system management code 204. The SMI handler 117 and the system management code 204 are stored and executable within a separate operating environment included in system management RAM (SMRAM) 206. The SMM code 204 determines whether or not the BIOS code 124 has permission to access the Master Boot Record 120, that is, the BIOS 124 code is authenticated by the SMM code 204. The BIOS code 124 is signed, that is, has a unique signature 208. The SMM code 204 determines from the signature 208 whether the BIOS code 124 is allowed to access the MBR 120. The determination is made by processor 102 comparing the result of subjecting the BIOS code signature 208 to a hashing algorithm 210 with a further signature 212 that is embedded within the SMM code 204 or stored within the SMM environment 206. Preferably, the signature 208 is passed to the SMM code 204 as an interrupt parameter in response to the generation of the SMI 116. Preferably, the encrypted MBR will have been encrypted using data derived from or associated with the BIOS 108 or the BIOS code 124. In preferred embodiments, the encrypted MBR is encrypted and decrypted using the BIOS code signature 208.

If the comparison shows that the BIOS code 124 is authentic, the signature 208 and the data contained within the Master Boot Record 120 are subjected to the hashing algorithm 210, which decrypts the Master Boot Record 120 to produce a decrypted Master Boot Record 214. The decrypted Master Boot Record 214 can be used to load the OS loader 122 and, ultimately, the operating system 118. Having determined that the BIOS code is authentic, the SMM code instructs the ICH2 to disable the trap that intercepts access attempts to the HDD 112 using a corresponding enable/disable signal 215.

If the comparison shows that the BIOS code 124 is inauthentic, neither the signature nor the data contained within the Master Boot Record is subjected to the hashing algorithm 210. Accordingly, the SMM code 204 is arranged to output a message containing an indication that the BIOS code 124 is inauthentic and the user should seek assistance from an authorized supplier of an appropriate, authentic, BIOS. The SMM code 204 is arranged to “hang” the computer system to prevent it from being used.

The signature 212 stored within the SMRAM 206 cannot be read in advance by user software or malicious software since the storage represented by the SMRAM 206 cannot be accessed other than during the system management mode of operation.

It is to be appreciated that the combination of an uninterruptible SMM routine including a hashing or decryption algorithm 210, an encrypted Master Boot Record 120, which is related to the BIOS code, and the BIOS code 124 including a signature 208, ensures that the Master Boot Record 120 can only be used by an authorized BIOS. This ensures that the hardware platform is tied to the BIOS. Hence, use of the hardware platform is restricted to the purpose for which it was sold or licensed.

Although the above embodiment has been described with reference to the ICH2 generating the SMI, embodiments are not limited to such an arrangement. Embodiments can be realized in which additional logic is provided to generate a SMI upon detection of any activity on, for example, the address bus to the HDD 112 or the address bus between the ICH2 106 and the IDE controller 110.

While the preferred embodiment has been described with reference to protecting a computer system hardware platform against hacking, the principles of the present invention are applicable equally to the protection of any hardware platform such as, for example, a scanner, an external HDD or other device having initialization data. Still further, the non-volatile storage can be a solid state storage such as a flash memory.

It will be appreciated that the above embodiment disables the interrupt trap once the BIOS has been determined to be authorized. However, embodiments can be realized in which the interrupt trap is permanently enabled and all or selected software executed by the computer system 101 must be authorized.

Furthermore, it will be appreciated from the above that the encrypted MBR is not overwritten with the decrypted BIOS. Therefore, the security measures represented by embodiments of the present invention will be in effect the next time the computer system 101 is booted. This mode of operation is preferred to one in which the decrypted MBR is written to the HDD to allow future access. Once the decrypted MBR has been written to the HDD, the protection afforded by the embodiments of the present invention is removed, in the absence of writing the encrypted MBR at some point in time before shut down.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) might be replaced by alternative features serving the same, equivalent or similar purpose unless expressly stated otherwise. Thus, unless expressly stated otherwise, each feature disclosed is one example only of a generic series of equivalent or similar features.

The invention is not restricted to the details of any of the foregoing embodiments. The invention extends to any novel one, or any novel combination, of the features disclosed in this specification (including any accompanying claims, abstract, and drawings), or to any novel combination, of the steps of any method or process so disclosed.

1. A data processing system comprising a processor, a non-volatile storage medium including configuration data that describes the configuration of the non-volatile storage medium, a controller for managing data exchanges with the non-volatile storage medium and for invoking an uninterruptible software routine in response to first software attempting to access the configuration data; the uninterruptible software routine having code for determining whether the first software is authorized to access the configuration data and for allowing or preventing any such access according to the determination.

2. The data processing system of claim 1, in which the first software is initialization software for initializing the data processing system.

3. The data processing system of claim 1, wherein the configuration data comprises at least a portion of first data included in a data structure of the non-volatile storage medium.

4. The data processing system of claim 3, wherein the data structure includes a Master Boot Record.

5. The data processing system of claim 1, wherein the configuration data comprises executable code.

6. The data processing system of claim 5, wherein the executable code includes Master Boot Code.

7. The data processing system of claim 1, wherein at least one of the configuration data and data associated with the first software are encrypted and the controller includes a decrypter of at least one of the configuration data and data associated with the first software.

8. The data processing system of claim 7, wherein the decrypter is arranged to decrypt at least one of the configuration data and the data associated with the first software for deriving decrypted configuration data for supporting access to the nonvolatile storage medium.

9. The data processing system of claim 8, wherein the data associated with the first software comprises a decryption key.

10. The data processing system of claim 7, wherein the data associated with the first software includes a software signature.

11. The data processing system of claim 7 wherein the decrypter is arranged to derive a decryption key in response to at least one of the data associated with the first software and the configuration data.

12. The data processing system of claim 1 wherein the interrupt includes an SMI interrupt and the uninterruptible software routine includes a system management mode code executable within a constrained or protected operating environment.

13. The data processing system of claim 1 further including an operating system loader for loading an operating system for the data processing system and wherein the configuration data is arranged to provide access to the operating system loader to load the operating system for the data processing system from the non-volatile storage medium.

14. The data processing system of claim I wherein the first software is at least one of an operating system or application.

15. A system comprising a processor, a first non-volatile storage medium having first and second firmware and a second non-volatile storage medium for storing configuration data that describes the configuration of the second non-volatile storage medium; the processor having a first mode of operation for executing the first firmware and a second mode of operation for executing the second firmware; the processor being arranged to enter the second mode of operation and execute the second firmware in response to the first firmware, executing in the first mode of operation, at least attempting to access the configuration data; the second firmware being arranged to determine whether the first software is authorized to access the configuration data.

16. A method of controlling a data processing system, the system comprising a processor, first non-volatile storage storing first software and an uninterruptible software routine for executing within respective modes of operation of the processor, and a second non-volatile storage medium storing configuration data associated with the second non-volatile storage medium; the first software having associated identification data; the method comprising the steps of: executing the uninterruptible software routine, in the second mode of operation of the processor, in response to the first software, executing within the first mode of operation of the processor, at least attempting to access the configuration data; determining whether the first software is authorized to access the configuration data; and controlling access to the configuration data according to that determination.

17. The method of claim 16 wherein the uninterruptible software routine includes accessing to authorization data and the step of determining comprises the steps of: comparing the identification data associated with the first software with the authorization data to determine whether or not they match; and authorizing access or otherwise to the configuration data according to the comparison.

18. The method of claim 17, wherein the comparing step comprises the steps of: subjecting at least the identification data to an algorithm to produce a processing result; comparing the processing result to the authorization data; and authorizing access or otherwise to the configuration data according to the comparison.

19. The method of claim 16, further comprising the steps of subjecting at least the configuration data to a configuration data algorithm to produce second configuration data.

20. The method of claim 19, wherein the subjecting step comprises subjecting the configuration data and identification data associated with the first software to the configuration data algorithm to produce the second configuration data.

21. A memory storing a computer program for causing the system of claim 16 to perform the method of claim 16.

22. The computer system of claim 16 programmed to perform the method of claim 16.
